(19) United States
(12) Patent Application Publication
(10) Pub. No.: US 2021/0042382 A1
(43) Pub. Date: Feb. 11, 2021

(54) SYSTEM AND METHOD OF SELECTING HUMAN-IN-THE-LOOP TIME SERIES ANOMALY DETECTION METHODS

(71) Applicant: Verint Americas Inc., Alpharetta, GA (US)

(72) Inventors: Cynthia Freeman, Spokane, WA (US); Ian Roy Beaver, Spokane, WA (US)

(21) Appl. No.: 16/985,511

(22) Filed: Aug. 5, 2020

Related U.S. Application Data
(60) Provisional application No. 62/883,355, filed on Aug. 6, 2019.
(60) Provisional application No. 62/982,914, filed on Feb. 28, 2020.
(60) Provisional application No. 63/033,967, filed on Jun. 3, 2020.

(51) Int. Cl. G06F 17/18; G06F 17/40; G06K 9/62

(52) U.S. Cl. CPC G06F 17/18; G06K 9/6226; G06F 17/40

(57) ABSTRACT

A system and method for selecting an anomaly detection method from among a plurality of known anomaly detection methods includes selecting a set of anomaly detections methods based on characteristics of the time series, such as missing time steps, trend, drift, seasonality and concept drift. From among the applicable anomaly detection methods, the selection may be further informed by annotated predicted anomalies, and based on the annotations, turning the parameters for each respective anomaly detection method. Thereafter, the anomaly detection methods are scored and then further tuned according to human actions in identifying anomalies or disagrees with anomalies in the time series.

### CROSS REFERENCE TO RELATED APPLICATIONS

This application is a non-provisional of Provisional Patent Application Ser. Nos. 62/883,355, filed Aug. 6, 2019, 62/982,914, filed Feb. 28, 2020, and 63/033,967, filed Jun. 3, 2020, which applications are hereby incorporated by this reference in their entireties for all purposes as if fully set forth herein.

### BACKGROUND

### Field

Embodiments of the present invention relate to selection of anomaly detection methods, specifically a system and method of selecting human-in-the-loop time series anomaly detection methods.

### Background

The existence of a time series anomaly detection method that performs well for all domains is a myth. Given a massive library of available methods, how can one select the best method for their application? An extensive evaluation of every anomaly detection method is not feasible. Existing anomaly detection systems do not include an avenue for interactive selection and human feedback, which is desired given the subjective nature of what even is anomalous.

Time series are used in almost every field: intrusion and fraud detection, tracking key performance indicators (KPIs), the stock market, and medical sensor technologies. One common use of time series is for the detection of anomalies, patterns that do not conform to past patterns of behavior in the series. The detection of anomalies is vital for ensuring undisrupted business, efficient troubleshooting, or even, in the case of medical sensor technologies, lower the mortality rate. However, anomaly detection in time series is a notoriously difficult problem for a multitude of reasons:
What is anomalous? What is defined as anomalous may differ based on application. The existence of a one-size-fits-all anomaly detection method that works well for all domains is a myth. In addition, inclusion of contextual variables may change initial perceptions of what is anomalous. Suppose, on average, the number of daily bike rentals is 100, and one day, it was only 10. This may appear anomalous, but if it is a cold, winter day, this is actually not so surprising. In fact, it might appear even more anomalous if there were 100 rentals instead. There are also different Ives of anomalies, and some anomaly detection methods are better than others at detecting certain types.
Online anomaly detection. Anomaly detection often must be done on real-world streaming applications. In a sense, an online anomaly detection method must determine anomalies and update all relevant models before the next time step. Depending on the needs of the user, it may be acceptable to detect anomalies periodically. Regardless, efficient anomaly detection is vital which presents a challenge.
Lack of labeled data. It is unrealistic to assume that anomaly detection systems will have access to thousands of tagged data sets. In addition, given the online requirement of many such systems, encountering anomalous (or not anomalous) behavior that was not present in the training set is likely.
Data imbalance. Non-anomalous data tends to occur in much larger quantities than anomalous data. This can present a problem for a machine learning classifier approach to anomaly detection as the classes are not represented equally. Thus, an accuracy measure might present excellent results, but the accuracy is only reflecting the unequal class distribution in the data. For example, if there are 100 data points and only 2 anomalies, a classifier can deem every point as non-anomalous and achieve 98% accuracy.
Minimize False Positives. It is important to detect anomalies accurately, but minimizing false positives is also a goal. This will avoid wasted time in checking for problems when there are none and causing alarm fatigue where serious alerts are overlooked.
What should I use? There is a massive wealth of anomaly detection methods to choose from.

### BRIEF SUMMARY OF THE DISCLOSURE

Accordingly, the present invention is directed to a system and method of selecting human-in-the-loop time series anomaly detection methods that obviates one or more of the problems due to limitations and disadvantages of the related art.

In accordance with the purpose(s) of this invention, as embodied and broadly described herein, this invention, in one aspect, relates to a method of selecting an anomaly detection method from a plurality of known anomaly detection methods, the method of selecting, comprising includes determining, by a computer analysis, if a time series includes any of predetermined types of characteristics; selecting, by a computer, a set of anomaly detection methods from the plurality of known anomaly detection methods based on any of the predetermined types of characteristics determined included in the time series; for each anomaly detection method in the selected set of anomaly detection methods, annotating predicted anomalies, and based on the annotation, tuning by the computer parameters for each respective anomaly detection method; and generating by the computer, an output score for each respective anomaly detection method.

In an aspect, the predetermined types of characteristics include missing time steps, trend, drift, seasonality, concept drift. If it is determined that the time series includes missing time steps, substituting in values for the missing time steps using an interpolative algorithm.

In an aspect, if any of the predetermined types of characteristics are present in the time series, a set of the known anomaly detection methods that are not sub-par for a first of the predetermined types of characteristics is identified.

In an aspect, if any of the predetermined types of characteristics are not present in the time series, perhaps at least one type of anomaly present in the time series may be identified.

In an aspect, if an anomaly is not identifiable in the time series, defining characteristics of the time series by clustering annotated time series by anomaly type. An anomaly detection method from the set of anomaly detection methods based on the output score.

Further tuning of the anomaly detection method with the highest output score to the time series, may be performed via computer, by eliminating predicted anomaly clusters in a sequence similar to prior human annotator identified anomaly. Predicted anomaly clusters for elimination are determined by applying a sigmoid function to affected anomaly scores.

Further tuning of the anomaly detection method with the highest output score to the time series, may be performed by, via computer, eliminating predicted anomaly clusters in a sequence similar to prior human annotator identified disagreement with the anomaly detection method. The tuning comprising creating a query by forming a subsequence of time series of length ts_affected with the disagreed-with anomaly centered in the subsequence to identify segments of the time series to be eliminated.

Further embodiments, features, and advantages of the system and method of selecting an anomaly detection method, as well as the structure and operation of the various embodiments of the system and method of selecting an anomaly detection method, are described in detail below with reference to the accompanying drawings.

It is to be understood that both the foregoing general description and the following detailed description are exemplary and explanatory only, and are not restrictive of the invention as claimed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are incorporated in and constitute a part of this specification, illustrate (one) several embodiment(s) of the invention and together with the description, serve to explain the principles of the invention.

Reference will now be made to the accompanying drawings, which are not necessarily drawn to scale. The accompanying figures, which are incorporated herein and form part of the specification, illustrate a system and method of selecting human-in-the-loop time series anomaly detection methods. Together with the description, the figures further serve to explain the principles of the system and method of selecting human-in-the-loop time series anomaly detection methods described herein and thereby enable a person skilled in the pertinent art to make and use the system and method of selecting human-in-the-loop time series anomaly detection methods

FIG. 1(a) shows an example time series exhibiting seasonality.

FIG. 1(b) shows an example time series exhibiting downward trend.

FIG. 1(c) shows an example time series exhibiting concept drift.

FIG. 1(d) shows an example time series exhibiting missing time steps.

FIG. 2 shows the posterior probability of the run length at each time step using a logarithmic color (gray) scale.

FIG. 3 shows a time series with a predicted anomaly and with a predicted anomaly that an annotator has to disagree with.

FIGS. 4(a)-(d) show a time series tracking the daily ambient office temperature with predicted anomalies. FIG. 4(a) shows the time series of the daily ambient office temperature without the application of Concept 1 and Concept 2 as described herein; FIG. 4(b) shows the times series after implementing only Concept 1 on predicted anomalies; FIG. 4(c) shows the time series after implementing only Concept 2; and FIG. 4(d) shows the time series after implementing Concept 1 and Concept 2.

FIG. 5 is a progress plot for the time series art_load_balancer_spikes using the anomaly detection method GLiM.

### DETAILED DESCRIPTION

Reference will now be made in detail to embodiments of the system and method of selecting human-in-the-loop time series anomaly detection methods with reference to the accompanying figures The same reference numbers in different drawings may identify the same or similar elements.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

Throughout this application, various publications may have been referenced. The disclosures of these publications in their entireties are hereby incorporated by reference into this application in order to more fully describe the state of the art to which this invention pertains.

Provided herein is a novel human-in-the-loop technique to intelligently choose anomaly detection methods based on the characteristics the time series displays such as seasonality, trend, concept drift, and missing time steps, which can improve efficiency in anomaly detection. Examples and exemplary determinations described herein that demonstrate the novel technique were made by extensively experimenting with over 30 pre-annotated time series from the open-source Numenta Anomaly Benchmark repository.

Once the highest performing anomaly detection methods are selected via these characteristics, humans can annotate the predicted outliers, which are used to tune anomaly scores via subsequence similarity search and to improve the selected methods for their data, increasing evaluation scores and reducing the need for annotation by perhaps 70%. Applying the present methodologies can save time and effort by surfacing the most promising anomaly detection methods, reducing the need for experimenting extensively with a rapidly expanding library of time series anomaly detection methods, especially in an online setting.

Accordingly, because of the difficulties inherent in time series anomaly detection, the present disclosure makes the following contributions: a novel, efficient, human-in-the-loop technique for the classification of time series and choice of anomaly detection method based on time series characteristics; an empirical study determining these methods by experimenting on over 30 pre-annotated time series from the open-source Numenta anomaly benchmark repository; and a description of how to incorporate user feedback on predicted outliers by utilizing subsequence similarity search, reducing the need for annotation perhaps by over 70%, while also increasing evaluation scores on our data.

There is a massive library of anomaly detection methods, so it can be difficult to determine the best performing method for an application. Accordingly, described herein is a technique for making this choice and yet also deal with the subjective nature of what an anomaly is by supplementing the technique with human input.

Yahoo EGADS and Opprentice are human in the loop anomaly detection systems with similar aims to that disclosed herein. However, there are some key differences. EGADS gives users two options: the user can choose (1) how to model the normal behavior of the time series such that a significant deviation from this model is considered an outlier or (2) which decomposition-based method to use with thresholding on the noise component. EGADS then gives users the predicted anomalies to annotate and trains a binary classifier to predict if an anomaly is relevant to the user. The classifier is given the time series and its characteristics such as kurtosis as features. Similar to EGADS, Opprentice also makes use of a classifier to determine what anomalies, but the features are the results of multiple anomaly detectors. Opprentice can only take detectors that (1) can work in an online setting and (2) output a non-negative value that measures the severity of the anomaly and use a threshold to determine if the severity is high enough to be considered an anomaly. The results (severity levels) of the detectors with human labeling of outliers comprise the training data set.

However, the presently described techniques focus on the characteristics present in the time series to first discard subpar anomaly detection methods. By filtering subpar methods, this technique increases efficiency in anomaly detection and saves time as there is no need to select from an ever-expanding library of anomaly detection methods. Users can directly begin working with more promising methods. This method also reduces the probability of potential error introduced by the filtering classifier.

Other popular frameworks include LinkedIn's Luminal, Etsy's Skyline, Mentat Innovation's datastream.io, and Lytics Anomalyzer, but none include human-in-the-loop.

One potential direction for choosing anomaly detection methods and parameters is AutoML, or Automated Machine Learning. At the most basic level, the user only needs to provide data and an AutoML system will automatically determine the best methodology and parameters for the given task. Unfortunately, existing AutoML approaches struggle with anomaly detection, as exemplified in the ChaLearn AutoML Challenge (Frank Hutter, Lars Kotthoff, and Joaquin Vanschoren. 2019. Automated Machine Learning-Methods, Systems, Challenges.). Large class imbalance was identified as being the reason for low performance by all teams in this challenge, even more so than data sets with a large number of classes. By definition of an anomaly, non-anomalous data should occur in much greater quantities than anomalous data, presenting a challenge for AutoML systems.

While similar to AutoML, the presently-disclosed method is specifically, tailored to anomaly detection, where class imbalance is present by definition. The presently-disclosed method uses an automated, data-driven approach to filter out less performant or inapplicable methods based on characteristics of the given time series. Hyperparameter optimization is difficult as large, annotated training datasets specific to an application are unlikely, to preexist. Therefore, a human-in-the-loop approach in which human feedback is used to tune the output of the best performing anomaly detection method is included in the present method, thereby eliminating erroneous anomalies for a specific application without requiring the user to be an expert in anomaly detection.

The presently-disclosed human-in-the-loop technique for tuning anomaly scores may be similar to, but is different from J Dinal Herath, Changxin Bai, Guanhua Yan, Ping Yang, and Shiyong Lu. 2019. RAMP: Real-Time Anomaly Detection in Scientific Workflows. (2019) and Frank Madrid, Shailendra Singh, Quentin Chesnais, Kerry Mauck, and Eamonn Keogh. 2019. Efficient and Effective Labeling of Massive Entomological Datasets. (2019). The former uses the matrix profile technique, but the present system can be applied with any time series anomaly detection method that outputs an anomaly score. The latter is no built for anomaly detection but for the classification of insect behavior.

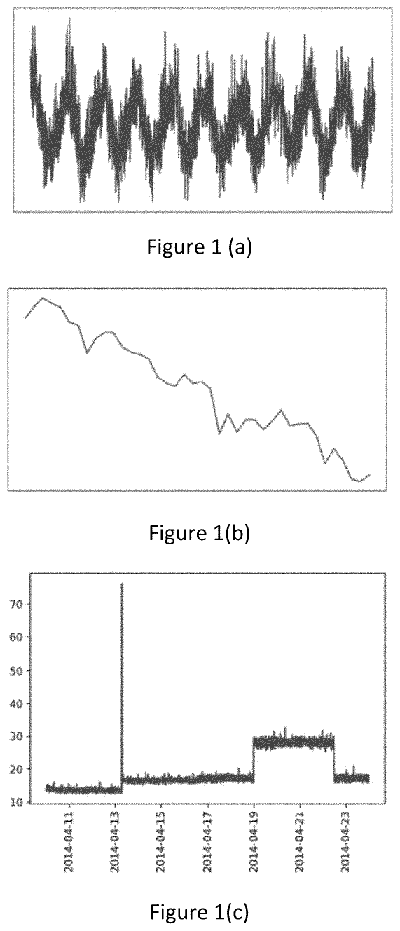

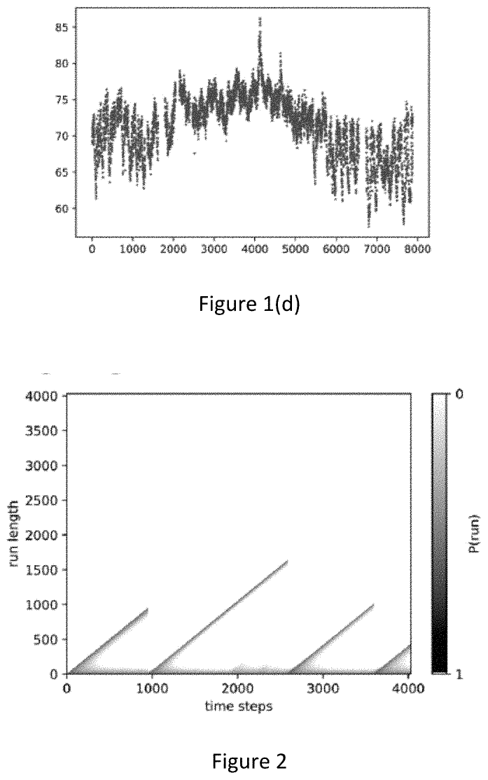

Referring to Algorithm 1, we propose an approach based on the characteristics (FIG. 1) a given time series (ts) possesses. FIG. 1 shows an example time series exhibiting seasonality (FIG. 1(a)), downward trend (FIG. 1(b)), concept drift around 2014 Apr. 19 and 2014 Apr. 2 and another concept drift around 2014 Apr. 13 shortly after an anomalous spike (FIG. 1(c)), and missing time steps (FIG. 1(d)). The time series in FIG. 1 are displayed as a scatter plot to showcase the missing points, especially around time step 6500.

Some anomaly detection methods perform better on certain characteristics than others. For example, if the time series in a user's application exhibits concept drift but no seasonality, the user may want to consider Facebook Prophet and not Twitter AnomalyDetection. For example, we begin by detecting characteristics in time series.

Time Series Characteristics

The list of characteristics provided herein is not comprehensive, but occur in many real world time series; they were present in all of the time series in Numenta's benchmark repository.

First, missing time steps (FIG. 1d) may make it difficult to apply anomaly, detection methods without some form of interpolation. However, other methods can handle missing time steps innately such as Facebook Prophet or SiRIMAX. The system determines the minimal time step difference in the input time series to find missing time steps. Using the smallest time step size is a technique employed in works such as Haowen Xu, Wenxiao Chen, Nengwen Zhao, Zeyan Li, Jiahao Bu, Zhihan Li, Ying Liu, Youjian Zhao, Dan Pei, Yang Peng, et al. 2018. Unsupervised Anomaly Detection via Variational Auto-Encoder for Seasonal KPIs in Web Applications. In Proceedings of the 2018 World Wide Web Conference on World Wide Web. International World Wide Web Conferences Steering Committee, 187-196 for nonuniformly sampled time series. The user can then decide if the missing time steps should be filled (fill in Algorithm 1) using some form of interpolation (e.g. linear, etc., called filloption) or if the system should limit the selection of anomaly detection methods to those that can innately deal with missing time steps.

Algorithm 1 is provided below.

Algorithm 1: Select Best Detection Method

| input | | | : ts |
|---|---|---|---|
| output | | | :best detection method |
| parameter | | | : threshₚₒₛₜ, lenᵣᵤₙ, fill, fillₒₚₜᵢₒₙ, siglevel |
| seasonality, trend, missing, conceptDrift ← false; | | | |
| selectedMethod ← none; | | | |
| if HasMiss(ts, fill, fillₒₚₜᵢₒₙ) then | | | |
| \| | if fill then ts ← FillTS(ts,fillₒₚₜᵢₒₙ) ; | | |
| \| | else missing ← true; | | |
| if HasConceptDrift(ts, threshₚₒₛₜ, then | | | |
| \| | conceptDrift ← true; | | |
| if FindFrequency(ts) > 1 then | | | |
| \| | seasonality ← true; | | |
| if CoxStuart(ts) < siglevel or AugmentedDickeyFuller(ts) | | | |
| >= siglevel then | | | |
| \| | trend ← true; | | |
| bestMethods ←FindBest(seasonality, trend, conceptDrift, | | | |
| missing); | | | |
| while selectedMethod is none do | | | |
| \| | for method in bestMethods do | | |
| \| | \| | outliers ←FindOutliers(ts, method); | |
| \| | \| | if User accepts outliers then | |
| \| | \| | \| | selectedMethod ← method; |
| \| | \| | \| | break; |
| \| | \| | else | |
| \| | \| | \| | tags ← User annotates outliers; |
| \| | \| | \| | TuneAnomalyScores(anomalyScores, tags) |

return selectedMethod

Next, the system determines if concept drift (FIG. 1c) is present in the time series where the definition of normal behavior changes over time. Concept drifts can be difficult to detect especially if one does not know beforehand how many concept drifts there are. In Ryan Prescott Adams and David J C MacKay (2007). Bayesian online changepoint detection. arXiv preprint arXiv:0710.3742 (2007), this number need not be known. An implementation of Adams and MacKay's changepoint detection is available in Johannes Kulick. 2016. Bayesian Changepoint Detection. https://github.com/hildensia/bayesian_changepoint_detection using t-distributions for every new concept, referred to as a run. The posterior probability (P (rₜ|x_{1:t})) of the current run rₜ's length at each time step (xᵢ for i=1 . . . t) can be used to determine the presence of concept drifts. The user selects a threshold for the posterior probability for what is considered to be a run (threshₚₒₛₜ) and also how long a run must be before it is a concept drift (lenᵣᵤₙ). For example, in FIG. 2, a user might determine that a run must be of at least length 1000 and posterior probabilities of the run must be at least 0.75 before being considered a concept drift.

Using the same time series as FIG. 1(c), FIG. 2 shows the posterior probability of the run length at each time step using a logarithmic color (gray) scale.

The system then determines if a time series contains seasonality, the presence of variations that occur at specific regular intervals. The present example of the presently-disclosed system makes use of the FindFrequency function in the R forecast library, which first removes linear trend from the time series if present and determines the spectral density function from the best fitting autoregressive model. By determining the frequency f that produces the maximum output spectral density value, FindFrequency returns 1/f as the periodicity of the time series. If no seasonality is present, 1 is returned.

Finally, the system determines if trend (FIG. 1(b)) is present in the time series. The present example of the presently-disclosed system detects two types of trend: stochastic (removed via differencing the time series) and deterministic (removed via detrending or removing the line of best fit from the time series). Stochastic trend may be identified using the Augmented Dickey-Fuller (ADF) test, and deterministic trends may be detected using the Cox-Stuart test.

A time series could potentially not display any of the characteristics discussed. In this situation, which anomaly detection methods should be used? One solution is to consider which anomaly detection methods are more promising given the types of anomalies (point, collective, etc.) present in the data set. However, anomalies are rare and the data may not be pre-annotated. Another potential option is to cluster time series and consider clusters to be “characteristics”. However, this would require a significant number of annotated time series and raises the question of what should be done if a time series does not fit into any existing cluster. In another case, it is possible to simply consider all anomaly detection methods initially which does not provide the run time savings, but the less performant methods will quickly drop out of consideration after the first few disagreements by the human annotator.

Offline Experimentation

The anomaly detection method experiments described herein cover a wide breadth of techniques. Some are probabilistic (VAE), others are frequency-based (Anomalous), some rely on neural networks (HTMs), and others rely on decomposition of the signal itself (SARIMAX, STL [6]). Implementation of the present system is not limited to the anomaly detection techniques used in the present examples and experiments. Other techniques may be used to determine various time series characteristics as appropriate.

In an experiment, we first performed an offline, comprehensive experimental validation on over more than 20 data sets on a variety of anomaly detection methods over different time series characteristics to form guidelines. https://s3-us-west-2.amazonaws.com/anon-share/icdm_2020.zip contains Jupyter notebooks for determining the presence of all characteristics and experiments for which methods are more promising given a characteristic. We either re-implemented or used existing libraries, See Appendix to test different anomaly detection methods on different time series characteristics (seasonality, trend, concept drift, and missing time steps).

We used 10 data sets for every characteristic as determined by using the techniques discussed above. Thus, every characteristic had a corpus of 10 data sets (Table 4 in the Appendix). For example, we determined how well Facebook Prophet performs on concept drift by observing its results on 10 time series data sets all exhibiting concept drift. Some of the data sets we used came from the Numenta Anomaly Benchmark repository, which consists of 58 pre-annotated data sets across a wide variety of domains and scripts for evaluating online anomaly detection algorithms. No multivariate data sets are provided in Numenta's repository. Meticulous annotation instructions for Numenta's data sets are available in Numenta. 2017, Anomaly Labeling Instructions. https://drive.google.com/file/d/0 B1_XUjaAXeV3YlgwRXdsb3Voa1k/view and in Lavin and S. Ahmad. 2015. The Numenta Anomaly Benchmark (White paper). https://github.com/NAB/wiki.

In cases where we did not use Numenta data sets, a human tagged the data sets for anomalies following the same Numenta instructions. There were also several instances where we injected outliers.

For seasonality, trend, and concept drift corpi, any missing time steps were filled using linear interpolation. For the missing time step characteristic corpus, we either chose data sets with missing time steps already or we randomly removed data points from data sets with originally no missing points to generate the corpus.

For anomaly detection methods that involve forecasting such as Facebook Prophet, we performed grid search on the parameters to minimize the forecasting error. Otherwise, we choose models and parameters as intelligently as possible based on discovered time series characteristics. For example, periodicity would be determined beforehand by virtue of using the FindFrequency function to determine presence of seasonality.

In experimentally testing anomaly detection methods on a wide variety of data sets, we revealed areas where many of these methods are lacking but are not brought to light. For example, the Windowed Gaussian, Twitter AnomalyDetection, HOTSAX, Anomalous, and HTM methods assume your time series have no missing time steps. Twitter AnomalyDetection, STL, and Anomalous can only be used with seasonal data sets, and in STL's case, the periodicity must be at least 4 (as we use STLPLUS in R).

We experimented with two different anomaly detection evaluation methods: windowed F-scores and Numenta Anomaly Benchmark (NAB) scores. Details on these two scoring methodologies are available in the appendix.

Guidelines

Using these two scoring methodologies, we provided guidelines (Table 1) based on these results.

TABLE 1

| | | | | Missing |
|---|---|---|---|---|
| | Seasonality | Trend | Concept Drift | Time Steps |
| Windowed Gaussian | | | | N/A |
| SARIMAX | ★ † | ★ † | † | |
| Prophet | † | ★ | | |
| Anomalous | | | | N/A |
| STL | | | | |
| Twitter | ★ | | | N/A |
| HOT-SAX | | | | N/A |
| GLiM | | † | ★ | ★ † |
| HTM | ★ † | | ★ † | N/A |

Table 1 is provided for selecting an anomaly detection method as most promising given a time series characteristic. A star (★) indicates the windowed F-score scheme favors the method whereas a cross (†) indicates Numenta Anomaly Benchmark scores (NAB) favors the method. If there is an N/A, it means that method is not applicable given that time series characteristic.

For example, for seasonality and trend, decomposition-based anomaly detection methods such as SARIMAX (seasonal auto-regressive integrated moving average with exogeneous variables) and Facebook Prophet perform the best. SARIMAX and Prophet have decomposition methods with components specifically built for seasonality and trend, which might explain their performance on this characteristic. For example, for SARIMAX, seasonal versions of the autoregressive component, moving average component, and difference are considered. The integrated portion of SARIMAX allows for differencing between current and past values, giving this methodology the ability to support time series data with trend.

For concept drift, more complex methods are necessary such as HTMs (hierarchical temporal memory networks). For missing time steps, the number of directly, applicable anomaly detection methods is drastically reduced. Although interpolation is an option, this does introduce a degree of error. If no interpolation is desired, SARIMAX, STL (seasonal decomposition of time series by Loess), Prophet, and Generalized Linear Models (GLiMs) are options.

As there is an ever expanding library of anomaly detection methods, we save users time by surfacing the most promising methods (bestMethods, in Algorithm 1). The definition of what is an anomaly is highly subjective, so human input may improve. the decision-making process. Although we automate as much of the process as we can (determining the presence of characteristics, narrowing down the search space of anomaly detection methods), it is not advisable to completely remove the human element.

For every selected anomaly detection method, its predicted anomalies (outliers) are given to the user to annotate (Is the predicted anomaly truly an anomaly?), and based on their decision, the parameters for that method can be tuned to reduce the error. Parameter tuning is dependent on the anomaly detection method. For example, if a method produces an anomaly score ϵ[0, 100] with an anomaly threshold of 75, the system could raise the threshold to reduce false positives. Using this feedback, the system learns to minimize false positives for the user's data.

However, there is a plethora of anomaly detection methods, each with their own parameters. Determining how to tune these parameters for every possible method is not feasible, especially as the number of anomaly detection methods increases. Many methods already output an anomaly score or can be easily converted to produce such an output. Thus, we tune the anomaly scores instead of the anomaly detection parameters for the sake of generalization.

Tuning Anomaly Scores

We tune anomaly scores (Algorithm 2) based on two concepts:

Concept 1: Eliminate predicted anomaly clusters to prevent alarm fatigue.

Concept 2: When there is a detected anomaly and the user disagrees with this prediction, similar instances of this behavior should not be detected.

Algorithm 2: Human-in-the-Loop Optimization
of Time Series Anomaly Scores

input :ts, detections, anomaly_scores, threshold
parameter :t.s_affected, min_weight, top_k, maxₓₛ, ϵ
xs ← [0, . . . , maxₓₛ] evenly spaced where len(xs)= ts_affected;
for x in xs do
└ ys.append(erf(x));
while detections! = [ ] do
| /* Concept 1 */
| weight_index ← 0;
| for i in range(detections [0] +1,
| detections [0] + 1 + ts_affected) do
|| anomaly_scores[i]s = ys[weight_index];
|└ weight_index+ = 1;
| /* Concept 2 */
| user_input ← Annotator agrees or disagrees with
| detections [0];
| if user_input = = disagree then
|| if detections [0]-int(ts_affected/2) > 0 then
||| / * Create query subsequence */
||| query = ts [detectios [0]-int.(ts_affected/2):
||| detections [0] + int.(ts_affected/2]:
||| indices, dists = MASS (ts. query);
||| |/* Get max discord distance */
||| top_discord_index = indices[-1];
||| discord = ts[top_discord_index;
||| top_discord_index + len(query)];
||| max_dist = norm(discord, query);
||| /* Get sigmoid function parameters */
||| $b = ln ( \frac{1 - min\_weight}{min\_weight} ) ;$
||| $k = \frac{ln ( e ) - b}{- max\_dist} ;$
||| /* Multiply anomaly scores to weights based
||| off of distance to query */
||| for l in range(len(indices)) do
|||| starting_index = indices [l];
|||| subseq_distance = dists [l];
|||| for m in range(starting_index,
||||starting_index + its_affected) do
└└└└└ $⌊ anomaly\_scores [ m ] *= \frac{1}{1 + e \text{?}}$
|/* Update detections for remainder of time series */
|new_detections ← [ ];
|for k in range(detections [0] + 1, len(anomaly_scores)) do
| if anomaly_scores [k] ≥ threshold then
└└ new_detectios.append(k);
|detections = new_detections;
|if detections = = [ ] then
|└ break;
|if len (anomaly_scores)-detections [0] < ts_affected then
|└ break;
$\text{?} \text{indicates text missing or illegible when filed}$

Concept 1

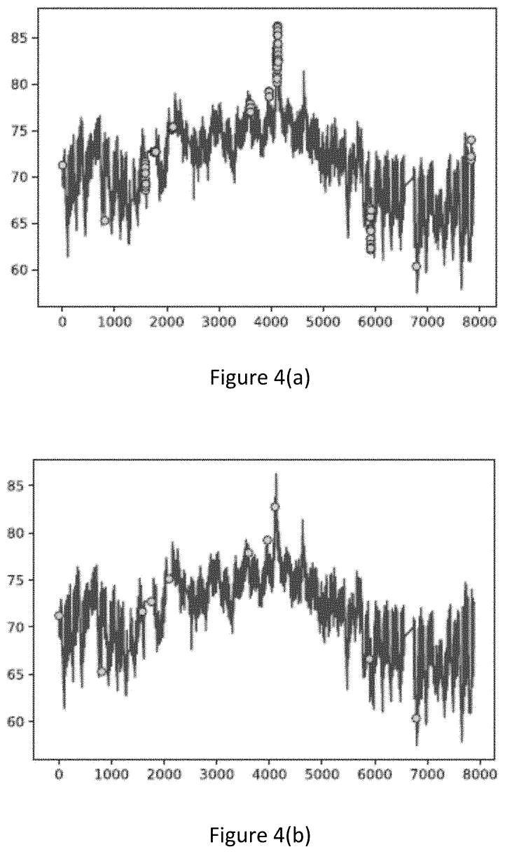

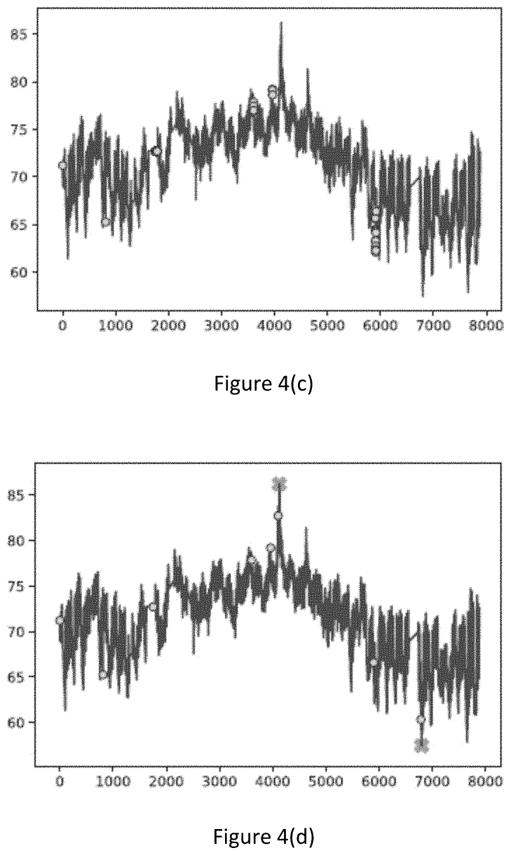

When an anomaly detection method predicts an anomaly in a time series, these predictions tend to occur in clusters like in FIG. 4(a), a time series tracking daily office temperatures from Numenta. 2018. The Numenta Anomaly Benchmark. https://github.com/numenta/NAB. On day 4200, there is a spike in temperature (85 degrees) and the arbitrarily chosen anomaly detection method (Facebook Prophet) detects a massive cluster of anomalies (yellow circles).

To prevent alarm fatigue, we keep the first detection in a cluster, but ignore remaining detections in the cluster. Given a predicted anomaly, we multiply ts_affected many anomaly scores following this predicted anomaly's time step by a sigmoid function, the error function

$$( erf ( x ) = \frac{1}{\sqrt{π}} {\int }_{- x}^{x} {e}^{- {t}^{2}} dt )$$

to briefly reduce the anomaly scores and prevent alarm fatigue due to clustered anomalies.

Concept 2

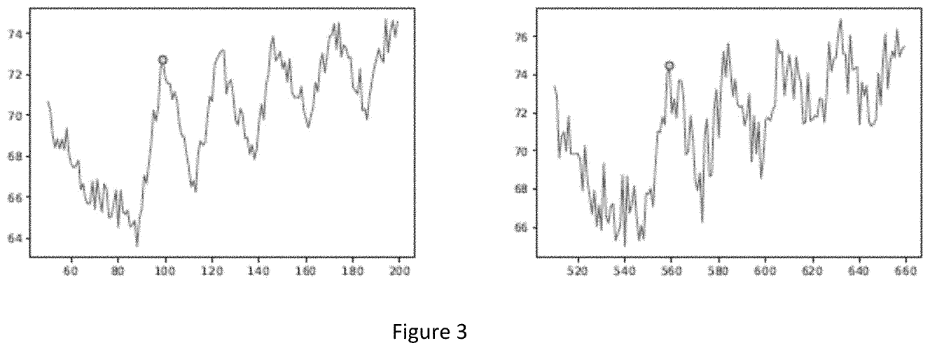

The left side of FIG. 3 shows a time series (blue line) with a predicted anomaly (yellow circle). The right side of FIG. 3 shows a similar pattern in the same time series, with a predicted anomaly that the annotator, unfortunately, has to disagree with.

Consider the time series on the left in FIG. 3. Suppose the annotator disagrees with the predicted anomaly (yellow circle) around time step 100. A very similar pattern occurs in the same time series around time step 500 (right), and the anomaly detection method predicts an anomaly in a similar location (time step 560). Chances are high that the annotator will, once again, disagree with this predicted anomaly. The goal is to take advantage of this knowledge and make it so that the prediction at time step 560 does not occur and waste the annotator's time. This means we have to find “similar chunks” of time series given a confirmed false positive.

In the present example, we determine these “similar chunks” by using Mueen's Algorithm for Similarity Search (MASS). MASS takes a query subsequence (a contiguous subset of values of a time series) and a time series, Is. MASS then returns an array of normalized Euclidean distances, dists, and the indices they begin on, indices, to help users identify similar (motifs) or dissimilar (discords) subsequences in is compared to the given query. MASS is presently the most efficient algorithm for similarity search in time series subsequences, with an overall time complexity of O (nlog(n)) where n is time series length. Other techniques may be used in place of MASS.

For every detected anomaly that the annotator disagrees with, a query is created by forming a subsequence of the time series of length ts_affected with the detection in the middle of the subsequence. We reduce the anomaly scores corresponding to these motifs by multiplying them to a sigmoid function:

$$y = \frac{1}{1 + {e}^{- kx + b}}$$

$$Where , \\ b = ln ( \frac{1 - min\_weight}{min\_weight} ) , k = \frac{ln ( ϵ ) - b}{- max\_distance}$$

The more similar the query is to the corresponding motif, the greater the reduction to anomaly scores. The minimum weight multiplied to the anomaly scores is min_weight, and how quickly the sigmoid function converges to 1 is determined from the max discord distance from the query, max_distance, also determined by virtue of using MASS.

We modify anomaly scores given the annotator disagreeing with a predicted anomaly, but why not also in cases of agreement? The number of disagreements tends to far outweigh the number of agreements, especially early on in the tuning cycle. In addition, when there is an agreement, although we could consider similar instances and pre-tag these as “agree” for the annotator for efficiency, as precision is a factor, we chose in this example to have the user actually annotate similar instances of agreement as a precaution. An alternative is to consider a method to increase the anomaly scores in similar instances. Thus, the method herein may include modifying the anomaly scores in cases of agreement.

Example Application of Anomaly Score Tuning

FIG. 4 shows a time series tracking the daily ambient office temperature where predicted anomalies are represented as yellow circles. The time series in FIG. 4(a) is without application of Concept 1 and concept 2 as described herein. As can be seen, a cluster of anomalies occurs around time step 4200. FIG. 4(b) shows the time series after implementing only Concept 1 on predicted anomalies. FIG. 4(c) shows the time series after implementing only Concept 2 on predicted anomalies. FIG. 4(d) shows the time series after implementing both Concept 1 and Concept 2 on predicted anomalies.

Let us reconsider the pre-annotated time series in FIG. 4(a), which tracks daily ambient office temperatures.

There are 119 predicted anomalies using anomaly scores generated from an arbitrarily chosen anomaly detection method, Facebook Prophet. If we only apply Concept 1, keeping the first predicted anomaly of a cluster by multiplying anomaly scores to an error function following a detection, we are reduced to 10 predicted anomalies (FIG. 4(b)). If we only apply Concept 2, removing false positives in similar subsequences, we are reduced to 52 predicted anomalies (FIG. 4(c)). with the intersection of these reduced anomalies from Concept 1 and 2 having a cardinality of 6. ts_affected=2% of time, series length, min_weight=0.95, maxxs=3, using ground truths from Numenta. 2018. The Numenta Anomaly Benchmark. https://github.com/numenta/NAB.

If we apply both Concept 1 and 2, we are reduced to just 8 detections (FIG. 4(d)). Critically, this 90% reduction does not miss the ground truth anomalies (red x's in FIG. 4(d)).

Results

To fully test our framework, we randomly chose 10 pre-annotated time series from Numenta not used in offline experimentations. We determined the characteristics present in each of these new time series and recorded the time in seconds taken to detect them in column Time Char of Table 2.

TABLE 2

| Dataset | Length | Characteristics | Time Char | # Anom | Time Opt | Time All | Best F |
|---|---|---|---|---|---|---|---|
| art_load_balancer_spikes | 4032 | Trend, Concept Drift | 4.16 | 1 | 64.98 | 146.60 | .5 |
| ec2_request_latency_system_failure | 4032 | Seasonality (3), Concept Drift, Miss | 4.09 | 3 | 48.12 | 48.12 | .86 |
| jjo_us-east-1_j-s2eb1ed9_NetworkIn | 1243 | Trend | 1.30 | 2 | 5.66 | 26.01 | .5 |
| rogue_agent_key_hold | 1882 | Missing, Concept Drift | 1.02 | 2 | 2.19 | 11.32 | .25 |
| ec2_cpu_utilization_fc7193 | 4032 | Seasonality (16), Trend | 11.11 | 1 | 64.32 | 343.97 | .8 |
| ec2_cpu_utilization_24ae8d | 4032 | Concept Drift | 4.52 | 2 | 47.81 | 441.61 | .67 |
| art_daily_jumpdown | 4032 | Seasonality (13), Trend | 11.65 | 1 | 43.44 | 326.63 | .67 |
| ec2_network_in_257a54 | 4032 | Seasonality (42), Trend, Concept Drift, Miss | 4.08 | 1 | 12.57 | 12.82 | .67 |
| exchange-4_cpc_results | 1643 | Concept Drift, Trend, Miss | .85 | 3 | 10.78 | 10.78 | .46 |
| exchange-4_cpm_results | 1643 | Concept Drift, Miss | .87 | 4 | 2.90 | 7.66 | .47 |

| | | Best Method | Either |
|---|---|---|---|
| Dataset | Best NAB | (using F/NAB) | In Opt |
| art_load_balancer_spikes | 41.08 | HTM/HTM | Y |
| ec2_request_latency_system_failure | 41.77 | Prophet/GLiM | Y |
| jjo_us-east-1_j-s2eb1ed9_NetworkIn | 40.78 | GLiM/HOTSAX | Y |
| rogue_agent_key_hold | 40.93 | SARIMAX/GLiM | Y |
| ec2_cpu_utilization_fc7193 | 41.10 | HTM/HTM | Y |
| ec2_cpu_utilization_24ae8d | 41.41 | HTM/HTM | Y |
| art_daily_jumpdown | 41.15 | GLiM/GLiM | Y |
| ec2_network_in_257aS4 | 40.72 | GLiM/Prophet | Y |
| exchange-4_cpc_results | 41.35 | Prophet/Prophet | Y |
| exchange-4_cpm_results | 41.64 | Prophet/SARIMAX | Y |

Table 2 provides of a summary of test data sets. Length is the number of time steps. Characteristics lists which characteristics the time series exhibits. If there is no seasonality, we include the number of time steps per period in parentheses. Time Char is the total time in seconds to detect all characteristics for the time series. #Anom is the number of ground truth anomalies in the data set as annotated by Numenta. 2018. The Numenta Anomaly Benchmark. https://github.com/numenta/NAB. Time Best is the total time to detect anomalies using only the predetermined “best” methods from Table 1 for the characteristics present whereas TimeAll is the total time to detect anomalies using all methods from Table 1. These are equal cases where some anomaly detection methods are not applicable due to seasonality and/or missing time steps. if the best windowed F-score or NAB score was achieved by a method (“Best Method” using F/NAB)) pre-determined to be the “best” performing, a ‘Y’ will appear under Either In Opt or ‘N’ otherwise. Note that the windowed F-scores and the NAB scores reported are before applying optimization of described herein.

If a data set contained missing time steps, we did not interpolate and relied on anomaly detection methods that can innately deal with missing time steps. Based on the presence of time series characteristics, we applied best performing anomaly detection methods listed in Table 1. For example, the time series ec2_cpu_utilization_24ae8d displays concept drift as determined by run length posterior probabilities, so Table 1 suggests that SARIMAX, GLiM, and HTM are the best anomaly detection methods to apply. The total time to detect anomalies with these three methods is 47.81 seconds. We compare it to the time it takes to apply all anomaly detection methods in Table 1, which is 441.61 seconds. However, the method returning the best windowed F-score or NAB score is HTM (for both scoring methodologies) which is in the best performing method set. Thus, it would be a waste of time comparing all methods; using just the best methods in Table 1 would save time and effort. These best methods were in fact the highest performing for both scoring methodologies for almost all ten randomly chosen time series we experimented with in Table 2. In only one case was it not best performing: HOTSAX for iio_us-east-1_i-a2eb1cd9_NetworkIn with NAB (although using windowed F− scores hits such a best method, GLiM). This is because NAB rewards early detection of anomalies (more so, than if the detection is exactly on the ground truth itself), and in this instance, HOTSAX detected anomaly scores earlier than other anomaly detection methodologies. See the Appendix, below or Numenta. 2018. The Numenta Anomaly Benchmark. https://github.com/numenta/NAB for more details on NAB scores.

We additionally experiment with Concepts 1 and 2. We create progress plots where the x-axis is the fraction of annotations already done, and the y-axis shows the fraction of annotations left. As the data sets used are already annotated by Numenta, we “annotate” by using the ground truths provided by Numenta. In the worst case scenario, every annotation only reduces the number of remaining annotations by 1 (y=1−x). This would mean that there are no anomaly detection clusters and no similar instances of confirmed false positives.

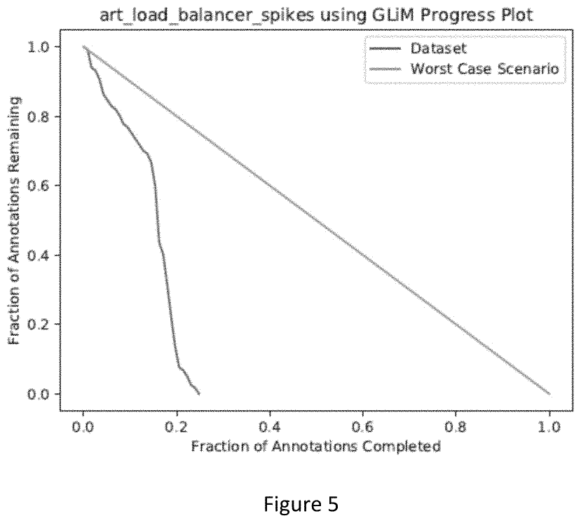

FIG. 5 is a progress plot for the time series art_load_balancer_spikes using the anomaly detection method GLiM. Only 24% of the predictions need to be annotated using MASS and cluster prediction elimination. Without removing clusters and applying MASS, 117 predictions would need to be reviewed by annotators. Using both Concept 1 and Concept 2, only 29 annotations are needed in total, reducing the fraction of needed annotations by almost 80%.

As an example of Concept 2, the annotator disagrees with the first prediction made by GLiM. MASS determines there is a similar subsequence further along in the time series containing a prediction not yet tagged and lowers the anomaly scores corresponding to this subsequence. Thus, instead of 117 annotations being reduced to 116 after a single annotation, we have 115 remaining. In all but the worst case, as the reviewer makes annotations, the number of annotations remaining goes down in steps greater than 1.

Out of the 67 time series and anomaly detection method combinations, only 9 had worst case scenario progress plots. In total, the number of predictions that would need to be annotated across all 67 combinations without prediction cluster elimination and MASS is 1, 701. Using MASS and prediction cluster elimination, the number of annotations required is 483, a 71.6% reduction in annotations. Average MASS running time after an annotation was 0.17 seconds across all 67 time series-method combinations. In addition, using the two concepts often increases evaluation scores due to the reduction in false positives. Table 3 displays the windowed F-scores of the best performing anomaly detection method without using MASS and prediction cluster elimination. from Table 2 versus using MASS and prediction cluster elimination on the same method.

On average, windowed F-scores increased by 0.14 by using MASS and prediction cluster elimination. In 8 out of 10 data sets, NAB scores either stayed the same or increased in value. We suspect this is because NAB explicitly rewards early detection of anomalies, and predictions made slightly before ground truths may have been removed using the two concepts, reducing the NAB scores. Unlike NAB, when using point-based precision and recall a detection slightly earlier than the ground truth anomaly would be punished. We use window-based precision and recall with the same size windows as NAB, but windows are not created around ground truth anomalies as in NAB. Instead, the entire time series is divided into equal sized windows. Thus, there is the possibility that a predicted anomaly may be rewarded under NAB as it is positioned in the same window as a ground truth anomaly but is earlier (left side of the window) but be punished under the window-based F-score system as the predicted. anomaly may be in an entirely different window from the ground truth anomaly.

Accuracy, alone, is not a good measure due to class imbalance (very few anomalies typically exist). To evaluate and compare the anomaly detection methods, we use the standard metrics of precision and recall to compute the F-score

$$( 2 \times \frac{precision \times recall}{precision + recall} ) .$$

An anomaly is considered to be the “True” class. We consider precision and recall on anomaly windows as points are too fine a granularity. An anomaly window is defined over a continuous range of points and its length can be user-specified. As an example, we use the same anomaly window size as Numenta. (10% of the length of a time series divided by 2)

NAB Scores

One night consider rewarding an anomaly detection method that detects outliers earlier rather than latter in a window. In addition, users may want to emphasize true positives, false positives, and false negatives differently. This gives rise to an application pro file, {A_{FN}, A_{TP}, A_{FP}}, which are weights for false negatives, true positives, and false positives, respectively. We use the standard application profile. See Alexander Lavin and Subutai Ahmad. 2015. Evaluating Real-Time Anomaly Detection Algorithms—The Numenta Anomaly Benchmark. In 2015 IEEE 14th International Conference on Machine Learning and Applications (ICMLA). IEEE, 38-44 for details.

Numenta creates a methodology to determine NAB anomaly scores based on application profiles. For every ground truth anomaly, an anomaly window is created with the ground truth anomaly at the center of the window. For every predicted anomaly, y, its score, σ(y), is determined by its position, pos(y), relative to a window, w that y is in or a window preceding y if y is not in any window. More specifically

$$σ ( y ) = ( {A}_{TP} - {A}_{FP} ) ( \frac{1}{1 + {e}^{5 pos ( y )}} ) - 1$$

if y is in an anomaly window. If y is not in any window but there is a preceding anomaly window w use the same equation as above, but determine the position of y using w. if there is no preceding window, α(y) is A_{FP}.

The score of an anomaly detection method given a single time series is

A_{FN}fₜₛ+Σ_{yϵY}_{ₜₛ}σ(y)

where fₜₛ represents the number of ground truth anomaly windows that were not detected (no predicted anomalies exist in the ground truth anomaly window), and Yₜₛ is the set of detected anomalies.

The score is then normalized by considering the score of a perfect detector (outputs all true positives and no false positives) and a null detector (outputs no anomaly detections).

More details on NAB scores are available in Numenta. 2018. The Numenta Anomaly Benchmark. https://github.com/numenta/NAB.

Data Used in Offline Experimentation

In Table 4, we display the data sets used in the offline experiments for determining the best anomaly detection method given a characteristic. We also determined the type of anomalies present in each data set: point or collective. A data point is considered a point anomaly if its value is far outside the entirety of the data set. A subset of data points within a data set is considered a collective anomaly if those values as a collection deviate significantly from the entire data set, but the values of the individual data points are not themselves anomalous. If collective, the first point in the subset is marked by Numenta. Note that anomalies can also be contextual. A data point is considered a contextual outlier if its value deviates from the rest of the data points in the same context. However, as we considered univariate data sets, no contextual outliers exist. Out of a total of 21 data sets, 16 contain anomalies that are point anomalies, and 9 contain collective anomalies.

TABLE 4

| | | | | | | | | | Outlier | | |
|---|---|---|---|---|---|---|---|---|---|---|---|
| Dataset | Length | Step | | Min | Max | Median | Mean | # Anom | Type | # Miss | Numenta |
| exchange-2_cpm_results | 1624 | 1 | hr | 0 | 1.051 | 0.295 | 0.337 | 2 | P | 23 | Y |
| elb_request_count_8c0756 | 4032 | 5 | min | 1 | 656 | 48 | 61.837 | 2 | P | 8 | Y |
| nyc_taxi | 10320 | 30 | min | 8 | 39197 | 16778 | 15137.569 | 5 | P, C | 0 (9) | Y |
| all_data_gift_certificates | 8784 | 1 | hr | 0 | 28 | 0 | 0.954 | 3 | P, C | 0 | N |
| FARM_Bowling-Green-5-S_Warren | 26465 | 30 | min | −2.490 | 30.304 | 15.455 | 14.830 | 3 | P, C | 0 | N |
| grok_asg_anomaly | 4621 | 5 | min | 0 | 45.623 | 33.445 | 27.685 | 3 | P | 0 | Y |
| rds_cpu_utilization_cc0c53 | 4032 | 5 | min | 5.190 | 25.103 | 6.082 | 8.112 | 2 | P | 1 | Y |
| rds_cpu_utilization_e47b3b | 4032 | 5 | min | 12.628 | 76.230 | 16.678 | 18.935 | 2 | P | 0 | Y |
| ambient_temperature_system_failure | 7267 | 1 | hr | 57.458 | 86.223 | 71.858 | 71.242 | 2 | P | 621 | Y |
| art_daily_flatmiddle | 4021 | 5 | min | −21.999 | 87.958 | −17.541 | 18.981 | 1 | C | 0 | Y |
| ec2_cpu_utilization_5f5533 | 4032 | 5 | min | 34.766 | 68.092 | 42.918 | 43.110 | 2 | P | 0 | Y |
| ec2_cpu_utilization_ac20cd | 4032 | 5 | min | 2.464 | 99.742 | 34.662 | 40.985 | 1 | P | 5 | Y |
| art_daily_nojump | 4032 | 5 | min | 18.001 | 87.973 | 21.382 | 40.818 | 1 | C | 0 | Y |
| artificial_cd_data set_1 | 800 | 5 | min | 1.008 | 19.973 | 9.986 | 10.110 | 3 | C | 0 (4) | N |
| artificial_cd_data set_2 | 1800 | 5 | min | 1.004 | 59.935 | 11.174 | 15.282 | 8 | P, C | 0 | N |
| artificial_cd_data set_3 | 1000 | 5 | min | 1.042 | 49.952 | 25.138 | 25.189 | 4 | P | 0 (3) | N |
| exchange-3_cpm_results | 1538 | 1 | hr | .321 | 5.498 | .695 | .773 | 1 | P | 109 | Y |
| exchange-2_cpc_results | 1624 | 1 | hr | .027 | .227 | .101 | .102 | 1 | C | 25 | Y |
| exchange-3_cpc_results | 1538 | 1 | hr | .039 | 1.054 | .118 | .137 | 3 | P | 109 | Y |
| international-airline-passengers | 144 | 1 | month | 104 | 800 | 265.5 | 283.389 | 1 | P | 0 | N |
| ibm-common-stock-closing-prices | 1008 | 1 | day | 306 | 598.50 | 460.625 | 462.818 | 1 | C | 452 | N |

| Dataset | Corpus |
|---|---|
| exchange-2_c9m_results | seasonal (24), trend, miss |
| elb_request_count_8c0756 | seasonal (288) |
| nyc_taxi | seasonal (48), miss |
| all_data_gift_certificates | seasonal (24), trend |
| FARM_Bowling-Green-5-S_Warren | seasonal (48) |
| grok_asg_anomaly | concept drift |
| rds_cpu_utilization_cc0c53 | concept drift, miss |
| rds_cpu_utilization_e47b3b | concept drift |
| ambient_temperature_system_failure | trend, seasonal (24), miss |
| art_daily_flatmiddle | concept drift |
| ec2_cpu_utilization_5f5533 | concept drift, trend |
| ec2_cpu_utilization_ac20cd | concept drift, trend, miss |
| art_daily_nojump | concept drift |
| artificial_cd_data set_1 | concept drift, miss |
| artificial_cd_data set_2 | concept drift |
| artificial_cd_data set_3 | concept drift, miss |
| exchange-3_cpm_results | trend, seasonal (24), miss |
| exchange-2_cpc_results | trend, seasonal (24), miss |
| exchange-3_cpc_results | trend, seasonal (24) |
| international-airline-passengers | trend, seasonal (12) |
| ibm-common-stock-closing-prices | trend, miss |

Table 4 is a summary of data sets used to determine best performing methods. Step is the time step size, Min is the minimum, Max is the maximum, $ Anom is the number of anomalies in the data set, Outlier Type indicates point (P) and/or collective (C) outliers in the data set, and #Miss is the number of missing time steps in the data set. A parenthesis indicates that the data set originally did not have missing data points, but we created another version of this data set with points randomly removed for the missing time step corpus. The Numenta column indicates if it originated from the Numenta repository. Corpus lists one or more characteristic corpi the data set belongs to. As we limit 10 data sets per characteristic, some data sets may exhibit a characteristic but not be placed in that corpus (e.g. elb_request_count_8c0756 has missing time steps but is not used in the missing time steps corpus). If there is seasonality, we include the number of time steps per period in parenthesis.

Experiments

We either re-implemented used existing libraries of the following anomaly detection methods: STL (seasonal decomposition of time series by Loess), RNNs (recurrent neural networks), Anomalous, SARIMAX (seasonal auto-regressive integrated moving average with exogeneous variables), Windowed Gaussian, Gaussian Processes, Facebook Prophet, Twitter AnomalyDetection, HOT-SAX, Generalized Linear Models, Hiearchical Temporal Memory Networks, Netflix SURUS, Variational Auto-Encoders, Gaussian Processes, etc. Some anomaly detection methods were experimented with but not included herein (although https://s3-us-west-2.amazonaws.comlanon-share/icdm_2020. zip contains experiments for these unincluded methods). These methods were not included either because they were exceedingly time consuming (making it difficult to apply in an online setting), considered overkill for univariate time series analysis, or due to presence of bugs in their open-source implementations (preventing experimentation).

### CONCLUSION

Anomaly detection is a challenging problem for many reasons, with one of them being method selection in an ever expanding library, especially for non-experts. Our system tackles this problem in a novel way by first determining the characteristics present in the given data and narrowing the choice down to a smaller set of promising anomaly detection methods. We determine these methods using over 20 pre-annotated time series and validate our system's ability on choosing better methods by experimenting with another 10 time series. We incorporate user feedback on predicted outliers from the methods in this smaller set, utilizing MASS and removing predicted anomaly clusters to tune these methods to the user's data, reducing the need for annotation perhaps by near 70% while increasing evaluation scores. Our system allows to quickly identify and tune the best performing anomaly detection method for their applications from a growing library of possible methods.

According to the principles above, a method of selecting an anomaly detection method from a plurality of known anomaly detection methods, the method of selecting, comprising includes determining, by a computer analysis, if a time series includes any of predetermined types of characteristics; selecting, by a computer, a set of anomaly detection methods from the plurality of known anomaly detection methods based on any of the predetermined types of characteristics determined included in the time series; for each anomaly detection method in the selected set of anomaly detection methods, annotating predicted anomalies, and based on the annotation, tuning by the computer parameters for each respective anomaly detection method; and generating by the computer, an output score for each respective anomaly detection method. The predetermined types of characteristics include missing time steps, trend, drift, seasonality, concept drift. If it is determined that the time series includes missing time steps, substituting in values for the missing time steps using an interpolative algorithm.

If any of the predetermined types of characteristics are present in the time series, a set of the known anomaly detection methods that are not sub-par for a first of the predetermined types of characteristics is identified. If any of the predetermined types of characteristics are not present in the time series, perhaps at least one type of anomaly present in the time series may be identified. If an anomaly is not identifiable in the time series, defining characteristics of the time series by clustering annotated time series by anomaly type. An anomaly detection method from the set of anomaly detection methods based on the output score.

Further tuning of the anomaly detection method with the highest output score to the time series, may be performed via computer, by eliminating predicted anomaly clusters in a sequence similar to prior human annotator identified anomaly. Predicted anomaly clusters for elimination are determined by applying a sigmoid function to affected anomaly scores.

Further tuning of the anomaly detection method with the highest output score to the time series, may be performed by, via computer, eliminating predicted anomaly clusters in a sequence similar to prior human annotator identified disagreement with the anomaly detection method. The tuning comprising creating a query by forming a subsequence of time series of length ts_affected with the disagreed-with anomaly centered in the subsequence to identify segments of the time series to be eliminated.

An exemplary method according to principles described herein is a method of human-in-the-loop algorithm selection including multiplying an anomaly score of a time series anomaly detection method by an error function; searching for similar instances of a behavior using MASS; and/or reducing the corresponding anomaly score using a sigmoid function scaled by a max discord distance and a user-chosen min_weight.

This disclosure also covers a system for automatically selecting an anomaly detection method from a plurality of known anomaly detection methods according to the methods described herein. This disclosure also covers computer readable non-transitory storage medium comprising computer-executable instructions that when executed by a processor of a computing device performs a method of automatically selecting an anomaly detection method from a plurality of known anomaly detection methods according to methods disclosed herein.

For example, the present framework may be performed by a computer system or processor capable of executing program code to perform the steps described herein. For example, system may be a computing system that includes a processing system, storage system, software, communication interface and a user interface. The processing system loads and executes software from the storage system. When executed by the computing system, software module directs the processing system to operate as described in herein in further detail, including execution of the cross-entropy ranking system described herein.

The processing system can comprise a microprocessor and other circuitry that retrieves and executes software from storage system. Processing system can be implemented within a single processing device but can also be distributed across multiple processing devices or sub-systems that cooperate in existing program instructions. Examples of processing system include general purpose central processing units, applications specific processors, and logic devices, as well as any other type of processing device, combinations of processing devices, or variations thereof.

The storage system can comprise any storage media readable by processing system, and capable of storing software. The storage system can include volatile and non-volatile, removable and non-removable media implemented in any method or technology for storage of information, such as computer readable instructions, data structures, program modules, or other data. Storage system can be implemented as a single storage device but may also be implemented across multiple storage devices or sub-systems. Storage system can further include additional elements, such a controller capable, of communicating with the processing system.

Examples of storage media include random access memory, read only memory, magnetic discs, optical discs, flash memory, virtual memory, and non-virtual memory, magnetic sets, magnetic tape, magnetic disc storage or other magnetic storage devices, or any other medium which can be used to storage the desired information and that may be accessed by an instruction execution system, as well as any combination or variation thereof, or any other type of storage medium. In some implementations, the store media can be a non-transitory storage media. In some implementations, at least a portion of the storage media may be transitory. It should be understood that in no case is the storage media a propagated signal.

While various embodiments of the present invention have been described above, it should be understood that they have been presented by way of example only, and not limitation. It will be apparent to persons skilled in the relevant art that various changes in form and detail can be made therein without departing from the spirit and scope of the present invention. Thus, the breadth and scope of the present invention should not be limited by any of the above-described exemplary embodiments, but should be defined only in accordance with the following claims and their equivalents.

We claim:

1. A method of selecting an anomaly detection method from a plurality of known anomaly detection methods, the method of selecting comprising:
determining, by a computer analysis, if a time series includes any of predetermined types of characteristics;
selecting, by a computer, a set of anomaly detection methods from the plurality of known anomaly detection methods based on any of the predetermined types of characteristics determined included in the time series;
for each anomaly detection method in the selected set of anomaly detection methods, annotating predicted anomalies, and based on the annotation, tuning by the computer parameters for each respective anomaly detection method; and
generating by the computer, an output score for each respective anomaly detection method.

2. The method of claim 1, wherein the predetermined types of characteristics include missing time steps, trend, seasonality, concept drift.

3. The method of claim 2, wherein if it is determined that the time series includes missing time steps, substituting in values for the missing time steps using an interpolative algorithm.

4. The method of claim 1, wherein the determining if the time series includes any of predetermined types of characteristics incudes determining if the time series exhibits concept drift.

5. The method of claim 1, wherein the determining if the time series includes any of the predetermined types of characteristics includes determining if the time series exhibits seasonality.

6. The method of claim 1, wherein the determining if the time series includes any of the predetermined types of characteristics includes determining if the time series exhibits trend.

7. The method of claim 1, further comprising, if any of the predetermined types of characteristics are present in the time series, identifying a set of the known anomaly detection methods that are not sub-par for a first of the predetermined types of characteristics;

8. The method of claim 7, further comprising, if any of the predetermined types of characteristics are not present in the time series, identifying at least one type of anomaly present in the time series.

9. The method of claim 8, further comprising if an anomaly is not identifiable in the time series, defining characteristics of the time series by clustering annotated time series by anomaly type.

10. The method of claim 1, further comprising selecting one anomaly detection method from the set of anomaly detection methods based on the output score.

11. The method of claim 1, further comprising:
tuning the anomaly detection method with the highest output score to the time series, by, via computer eliminating predicted anomaly clusters in a sequence similar to prior human annotator identified anomaly.

12. The method of claim 11, wherein predicted anomaly clusters for elimination are determined by applying a sigmoid function to affected anomaly scores.

13. The method of claim 1, further comprising:
tuning the anomaly detection method with the highest output score to the time series, by, via computer, eliminating predicted anomaly clusters in a sequence similar to prior human annotator identified disagreement with the anomaly detection method.

14. The method of claim 13, the tuning comprising creating a query by forming a subsequence of time series of length ts_affected with the disagreed-with anomaly centered in the subsequence to identify segments of the time series to be eliminated.

15. The method of claim 1, further comprising multiplying an anomaly score by an error function.

16. The method of claim 15, further comprising searching for similar instances of a behavior using MASS and reducing the corresponding anomaly score using a sigmoid function scaled by a max discord distance and a user-chosen min_weight.

17. The method of claim 1, further comprising searching for similar instances of a behavior using MASS and reducing the corresponding anomaly score using a sigmoid function scaled by a max discord distance and a user-chosen min_weight.

18. A system for automatically selecting an anomaly detection method from a plurality of known anomaly detection methods, the system comprising a processing system comprising computer-executable instructions stored on memory that can be executed by a processor in order to:
determine, by a computer analysis, if a time series includes any of predetermined types of characteristics;
select, by a computer, a set of anomaly detection methods from the plurality of known anomaly detection methods based on any of the predetermined types of characteristics determined included in the time series;
generate by the computer, an output score for each respective anomaly detection method,
wherein, for each anomaly detection method in the selected set of anomaly detection methods, predicted anomalies have been annotated, and:
based on the annotation, tune parameters for each respective anomaly detection method.

19. A computer readable non-transitory storage medium comprising computer-executable instructions that when executed by a processor of a computing device performs a method of automatically selecting an anomaly detection method from a plurality of known anomaly detection methods, the method comprising:
determining, by a computer analysis, if a time series includes any of predetermined types of characteristics;
selecting, by a computer, a set of anomaly detection methods from the plurality of known anomaly detection methods based on any of the predetermined types of characteristics determined included in the time series;
for each anomaly detection method in the selected set of anomaly detection methods, annotating predicted anomalies, and based on the annotation, tuning by the computer parameters for each respective anomaly detection method; and
generating by the computer, an output score for each respective anomaly detection method.

20. A method of human-in-the-loop algorithm selection comprising:
multiplying an anomaly score of a time series anomaly detection method by an error function;
searching for similar instances of a behavior using MASS; and
reducing the corresponding anomaly score using a sigmoid function scaled by a max discord distance and a user-chosen min_weight.
